(19) United States
(12) Patent Application Publication
(10) Pub. No.: US 2025/0337449 A1
(43) Pub. Date: Oct. 30, 2025

(54) TRACKING SYSTEM

(71) Applicant: Metabowerke GmbH, Nuertingen (DE)

(72) Inventors: Christian Moersch, Esslingen (DE); Dirk Wilke, Grabenstetten (DE); Julian Witkowski, Deizisau (DE)

(73) Assignee: Metabowerke GmbH, Nuertingen (DE)

(21) Appl. No.: 19/188,750

(22) Filed: Apr. 24, 2025

(30) Foreign Application Priority Data
Apr. 25, 2024 (DE) 102024111633.1

(51) Int. Cl. H04B 1/3877; H04W 4/029

(52) U.S. Cl. CPC H04B 1/3877; H04W 4/029

(57) ABSTRACT

A tracking system for wirelessly locating a connected object includes a tracking device having a housing for receiving a transmission installation for wireless transmission of location data to an external apparatus, wherein the housing of the tracking device has at least one fastening clearance for releasably receiving a fastening element; and at least one holding bracket, wherein the holding bracket is releasably connectable to the housing of the tracking device and has a connection contour which is configured to establish a form-fitting connection to a mating contour of an object to be connected to the tracking system in such a manner that the tracking device of the tracking system for wirelessly locating the connected object is configured to be releasably fastened to the object to be located by means of the holding bracket or by means of a fastening element.

### PRIORITY

The present Application for Patent claims priority to German Patent Application No. 102024111633.1 entitled “TRACKING SYSTEM” filed Apr. 25, 2024 and assigned to the assignee hereof and hereby expressly incorporated by reference herein.

### BACKGROUND

Trackers may be coin-shaped and can be received directly in an object to be located (tracked), such as a bag or purse, or in an additional holder made of plastic or leather, in order to be attached to an object to be located. In these ways, trackers of this type serve as pocket finders or key finders. Conventional trackers are not able to be attached to objects having different physical configurations.

### BRIEF DESCRIPTION OF THE FIGURES

The invention is described in more detail below with reference to the accompanying figures. The figures show a plurality of features of the invention in combination with one another. Of course, a person skilled in the art is also capable of considering said features separately from one another and of optionally combining them into further meaningful sub-combinations without having to undertake an inventive step for this purpose.

FIGS. 1a and 1b show in FIG. 1a an embodiment of the tracking system according to the invention, and in FIG. 1b the tracking system according to the invention according to FIG. 1a in a state attached to an object to be located.

FIG. 2 shows the tracking system according to FIGS. 1a, 1b in disassembled form.

FIG. 3 shows a tracking device of the tracking system according to FIGS. 1a, 1b and FIG. 2 in a top view.

FIG. 4 shows the tracking device according to FIG. 3 in combination with alternative fastening means in an isometric view.

FIGS. 5a, 5b show in FIG. 5a a tracking system in a lateral view, and in FIG. 5b the tracking system according to FIG. 5a in a state attached to an object to be located.

FIGS. 6a, 6b show in a sectional lateral view in FIG. 6a a tracking system, and in FIG. 6b the tracking system according to FIG. 6a in a state attached to an object to be located.

### DETAILED DESCRIPTION

The invention relates to a tracking system for wirelessly locating a connected object, having a tracking device comprising a housing for receiving a transmission installation for the wireless transmission of location data to an external apparatus, wherein the housing of the tracking device has at least one fastening clearance for releasably receiving a fastening element.

In one embodiment, the fastening elements are screws such as, for example, self-cutting tapping screws, which are inserted through holes in the bracket and into a surface of the object. Alternatively, the fastening elements may also be bolts that are guided through the holes, and through holes in the surface of the object, and secured to the object by nuts on the opposite side of the fastening structure. The housing of the tracking device in turn is attached to the bracket with the aid of fasteners. In one embodiment, the fastening elements are likewise formed as screws that are screwed into the threaded holes in the bracket. In another embodiment, the housing can be attached to the mounting bracket by means of a removable adhesive pad.

In an assembled state of the tracking device, when the housing is attached to the bracket, the housing covers the fastening means by way of which the bracket is attached to the surface of the object in such a manner that the fastening elements are therefore inaccessible to any tool that could be used for their removal. Accordingly, the presence of the housing prevents the bracket from being removed from the surface of the object. To gain access to the fastening elements in order to remove the bracket from the unit, the housing thus must first be removed from the bracket.

An additional unit tracking device, for example with a GPS module (Global Positioning System), allows the determination of the location coordinates of the tracking device on the basis of the time signals received from GPS satellites. A control apparatus containing microprocessor hardware and firmware is connected to the GPS module and a wireless modem and controls the operation of the tracking device. A battery supplies a current to the GPS module, the control apparatus, and the wireless modem.

A switch can furthermore be electrically connected to the control apparatus and can be triggered or switched as soon as the housing is released from the bracket. In this way, an unauthorized removal of the tracking device from the bracket and the object to be located can be determined.

Tracking devices are also known in connection with power tools and battery packs used with them.

For example, EP 3189943 A1 discloses a transmission installation as a constituent part of a stacking container, or for use in a stacking container, wherein a container body of the stacking container has a stowage receptacle, which is delimited by a base wall on the lower side of said container body and by circumferential walls projecting from the base wall to the upper side of said container body, for receiving a container insert which has a transport receptacle for transporting an electric or pneumatic hand-held power tool or an accessory part of a hand-held power tool of this type, wherein the stacking container for forming a stacked arrangement is designed having at least one additional stacking element, in particular designed as a stacking container, on which the stacking container by way of its lower side is stackable, or which is stackable on the upper side of the stacking container, wherein the transmission installation for transmitting data and/or energy has bus interfaces which are in particular connected to one another by a line arrangement and which in the state of the stacking containers stacked on top of one another form a bus connection between the stacking containers.

A basic concept herein provides that the components of the transmission installation are not constituent parts of the stacking container, but conjointly with the container insert form a transmission module. Thus, the stacking container can be designed quasi as a simple carrying container or hollow shaped body, which does not need any electrical components or in any case does not comprise the bus interfaces per se. The electrical equipment, or the equipment with the bus interfaces, is provided by the transmission module for the stacking container. Thus, simple, quasi conventional stacking containers can be used, which are enabled by the container insert with the transmission installation for establishing the bus connection, so to speak.

It is also advantageous to have a tracking device as a constituent part of the transmission installation and/or the container insert and/or the stacking container, wherein the locating installation for wirelessly locating the stacking container or the hand-held power tool received therein, or its accessory parts, is provided by means of an operator apparatus. Again, it is also advantageous that the tracking device does not necessarily have to form a constituent part of the stacking container but is provided, for example, on the container insert or the transmission installation.

A further tracking device for a hand-held electric power tool is disclosed in the application US 2019/0160646 A1. This shows a clip with an integrated tracking device, wherein the clip is formed substantially U-shaped with two holding arms, wherein a fastening receptacle for receiving a fastening screw is provided on at least one arm. The holding arms of the clip define a receptacle opening in which the hand-held electric power tool is held in place when the clip is fastened to the hand-held electric power tool. When the clip is fastened to the hand-held electric power tool, the at least one fastening receptacle of the one arm is co-aligned with a fastening receptacle on the hand-held electric power tool.

Finally, different design embodiments of a clip-like fastening possibility for sports accessories are disclosed in EP 4 336 005 A1.

In the light of the known prior art, an object of the present invention is to provide a tracking system having a tracking device which enables a multifunctional use and a secure fastening to an object to be located.

This object is achieved by a tracking system having the features of claim 1.

Accordingly, the tracking system for the wireless location of a connected object comprises a tracking device comprising a housing for receiving a transmission installation for the wireless transmission of location data to an external apparatus.

Such a transmission installation can be designed, for example, as a transmission installation or communication installation which is switched to active operation, for example is “always on”, independently of any manual activation caused by an operator. However, it is also conceivable that the transmission installation can be activated manually by an operator in at least one method step. Furthermore, the transmission installation can be designed as a WLAN transmission installation, as a Bluetooth transmission installation, as a radio transmission installation, as an RFID transmission installation, as an NFC transmission installation, as an infrared transmission installation, as a mobile network transmission installation, as a ZIGBEE transmission installation, or the like. In addition to a wireless transmission of location data, the transmission installation can also be designed for the transmission of location data to an external apparatus by wire.

The external apparatus can be designed as a smartphone, as a personal computer, as a laptop, as a netbook, as a tablet, as a watch, as an electronic bracelet or as another external unit deemed expedient by a person skilled in the art. The external apparatus or the external unit comprises at least one locating unit which is designed to evaluate the location data received from the transmission installation in order to detect a local and/or global position of an object connected to the tracking system.

The transmission installation is received in a housing of the tracking device, wherein the housing can comprise a wide variety of shapes, dimensions and housing materials. Depending on the intended use, the housing can also be designed in particular as a waterproof housing. The housing can be assembled in a known manner from a plurality of housing parts which are releasably or non-releasably connected to one another. It is essential to the invention that the housing has at least one fastening clearance, which is designed for releasably receiving a fastening element. The fastening element can comprise, in particular, a fastening screw, a fastening rivet or the like, for example. The fastening element can be particularly suitable for releasably fastening the tracking device directly to the object to be located, for example by guiding a fastening screw through the fastening clearance on the housing of the tracking device and screwing the fastening screw into the object to be located.

According to the invention, the tracking system furthermore comprises at least one holding bracket, wherein the holding bracket is releasably connectable to the housing of the tracking device, and has a connection contour which is able to establish a form-fitting connection to a mating contour of an object to be connected to the tracking system. Such a holding bracket has the advantage that the latter, and in particular its connection contour, can be tailored to a mating contour of the object to be located, so as to provide a secure fastening of the holding bracket and the connected tracking device.

The holding bracket is made of a dimensionally stable material, for example, of plastics material or a metallic material, at least in the region of the connection contour.

Owing to the fact that the holding bracket by way of its connection contour establishes a form-fitting connection to the mating contour of the object to be located, the possibility is furthermore provided to attach the tracking device to an object simply, quickly and without additional tools.

The object to be located, to which the tracking system can be attached, has as a mating contour, for example, a specific edge, a holding web, a receptacle, a shoulder or the like, with which the connection contour of the holding bracket is able to produce a form-fitting connection.

In particular, the holding bracket can have a connection contour such as is adapted to a mating contour already present on the object to be located, so that retrofitting a tracking system to an object to be located is possible.

Owing to the specific design of the tracking system, in which the tracking device can, via its housing and a fastening element that can be connected to the housing, be releasably fastened directly to the object to be located, and the provision of an additional holding bracket which can, via a fastening element, likewise be releasably connected to the housing of the tracking device, it is possible to releasably fasten the tracking device to different objects.

While known tracking devices usually have a simple housing without fastening possibilities or with only a single fastening possibility, a large variety of fastening possibilities are provided thereby, thus noticeably improving the potential use.

According to a refinement of the invention, the holding bracket can be releasably connectable to the housing by means of a fastening element which is received in the fastening clearance of the housing of the tracking device. It is thus possible, for example with a screw, to fasten the tracking device directly to the object to be located, or to attach the housing of the tracking device to the holding bracket with a screw, wherein the holding bracket can in turn be releasably connected via a form-fitting connection to the object to be located.

Of course, however, it is also conceivable to releasably connect the holding bracket in another way to the housing of the tracking device, for example via a latching contour formed directly on the holding bracket, fastening protrusions, or the like, which in turn achieve that the housing of the tracking device is received by way of a form-fitting engagement therewith. It is also fundamentally conceivable that the housing of the tracking device is adhesively bonded to the holding bracket (materially integral connection), or the like.

According to a refinement of the invention, it can be provided that the housing of the tracking device has at least one first fastening clearance for receiving a fastening element of a first type, and at least one second fastening clearance for receiving a fastening element of a second type, wherein the fastening element of the first type and the fastening element of the second type differ in terms of their dimensions, their type of material and/or the type of fastening effected. For example, it can be provided that the first fastening clearance is designed for receiving a fastening element formed as a fastening screw, while the at least one second fastening clearance, for example, is designed for receiving a fastening element formed as a cable tie or the like. In this case, the first and second types of fastening elements differ both in terms of their dimensions, as well as in terms of their type of material and the manner in which fastening is effected. Alternatively, however, it is also conceivable that the fastening clearance of the first type and the fastening clearance of the second type simply differ only in terms of their diameter, so that differently sized fastening elements (for example screw bolts or the like) can be accommodated. It is also conceivable that more than one first fastening clearance and/or more than one second fastening clearance, for example two, three, four or more first and/or second fastening clearances, are provided.

Furthermore, it can be provided that the housing of the tracking device has at least one third fastening clearance. This can be formed in particular in the manner of a groove extending from a lateral face of the housing in a longitudinal direction and opening into the first and/or the second fastening clearance. The housing can have a housing face which for fastening to an object can be placed against the latter (so-called contact face). The groove is attached to the contact face and extends from a lateral face of the housing adjacent to the contact face (toward which said groove is not delimited) in the manner of a channel up to the first and/or the second fastening clearance, opening into the latter.

This configuration allows a cable tie in the groove on the contact face to be able to be guided up to the corresponding first or second fastening clearance. As a result, this allows the contact face of the housing to rest on the object to be located without play, or almost without play, even when using fastening elements such as a cable tie or a strap.

The third fastening clearance can be shaped in particular in such a way that it has its smallest depth in the region of the lateral face of the housing and its greatest depth in the transition region to the first and/or second fastening clearance. The depth of the groove thus denotes its extent from the contact face of the housing to the groove base. Furthermore, the depth of the groove can be designed to increase linearly, progressively or regressively. Mixed forms are also conceivable. The groove-shaped third fastening clearance enables that even less flexible fastening elements, which when deflected from the first or the second fastening clearance do not have a kink but a curvature radius, can be guided within the third fastening clearance in order to enable resting of the contact face of the housing on the object to be located without play, or almost without play.

According to a refinement of the invention, it can be provided alternatively or additionally that the tracking system has at least one first holding bracket having a first connection contour, and at least one second holding bracket having a second connection contour, wherein the first connection contour and the second connection contour differ in terms of the contour shape in such a manner that the first connection contour is connectable in a form-fitting manner to a first mating contour on the object to be located, and the second connection contour is connectable in a form-fitting manner to a second mating contour on the object to be located.

It is thus possible that the tracking system comprises a housing and a plurality of holding brackets, wherein the holding brackets can be simultaneously attached to the housing of the tracking device, or only one of the holding brackets can in each case be connected to the housing. By providing different brackets with different connection contours, the tracking device can be furthermore enhanced with regard to its possible use, or the connectable objects to be located, respectively.

Of course, it is possible to provide more than two holding brackets with two different connection contours.

In combination with the above features, or independently thereof, it can be provided that the at least one holding bracket comprises two holding webs, wherein at least one of the holding webs is elastically deflectable relative to the other holding web, and wherein at least one holding web has a protrusion which can in the manner of a latching pawl be brought to engage in a form-fitting manner with the mating contour of the object to be located. The specific design embodiment of the protrusion on the at least one holding web is in particular a function of the mating contour of the object to be located.

Furthermore, the present invention relates to a container system comprising a container having at least one mating contour on a container wall, and at least one tracking system having the above features.

The container of the container system according to the invention thus forms the object to be located, or a part of the object to be located, if the container system has further components in addition to the container and the tracking system. On the container, a contour which assumes the function of the mating contour of the object to be located can be provided on one of the container walls in the external region or in the internal region. This contour can be specially designed for receiving, or connecting in a form-fitting manner to, the connection contour of the holding bracket of the tracking system, or comprise an already provided contour of the container.

According to one embodiment of the invention, the at least one mating contour can comprise a receptacle in which, in a state of the tracking system fastened to the container, the at least one holding bracket can be received at least in portions. The receptacle can thus be a clearance, a housing-shaped receptacle, a sleeve-shaped receptacle or the like, which makes it possible, at least in portions, to engage across, to encompass or to receive part of the holding bracket.

According to a conceivable variant of design embodiment, it can be provided that the at least one mating contour comprises a housing-shaped receptacle in which the tracking system can be received completely in such a way that an outer face of the tracking system in the received state of the tracking system is able to close almost flush with an adjacent face of a container wall.

In addition, it should be noted that expressions such as “comprising”, “having” or “with” do not exclude any other features or steps. Furthermore, expressions such as “a” or “the” that refer in the singular to steps or features do not exclude a plurality of features or steps, and vice versa.

Further features and advantages of the invention emerge from the description below of an exemplary embodiment of the invention and from the dependent claims.

The figures show an embodiment of a tracking system according to the invention for wirelessly locating a connected object O, which is generally referred to with the reference sign 10. The tracking system 10 comprises: a tracking device 12 having a housing 14 for receiving a transmission installation (indicated by the reference sign S in FIG. 3) for wirelessly transmitting location data to an external apparatus (not shown), wherein the housing 14 of the tracking device 12 has at least one fastening clearance 16, 18a, 18b, 18c, 18d for releasably receiving a fastening element.

Furthermore, the tracking system 10 according to the invention comprises at least one holding bracket 20, wherein the holding bracket 20 is releasably connectable to the housing 14 of the tracking device 12 and has a connection contour 22 which is able to establish a form-fitting connection to a mating contour 32 of an object O to be connected to the tracking system. In this way, the tracking device 12 of the tracking system 10 for wirelessly locating the associated object O by means of the holding bracket 20 can be releasably attached to an object O to be located.

In FIG. 4 it is shown that the tracking device can additionally also be connected to an object O to be located by means of an additional fastening element 40 (FIG. 4). In the embodiment shown, two additional fastening elements 40 are provided, which can in the manner of a cable tie, a wire, belt or another substantially elongate flexible fastening element be attached to an object to be located.

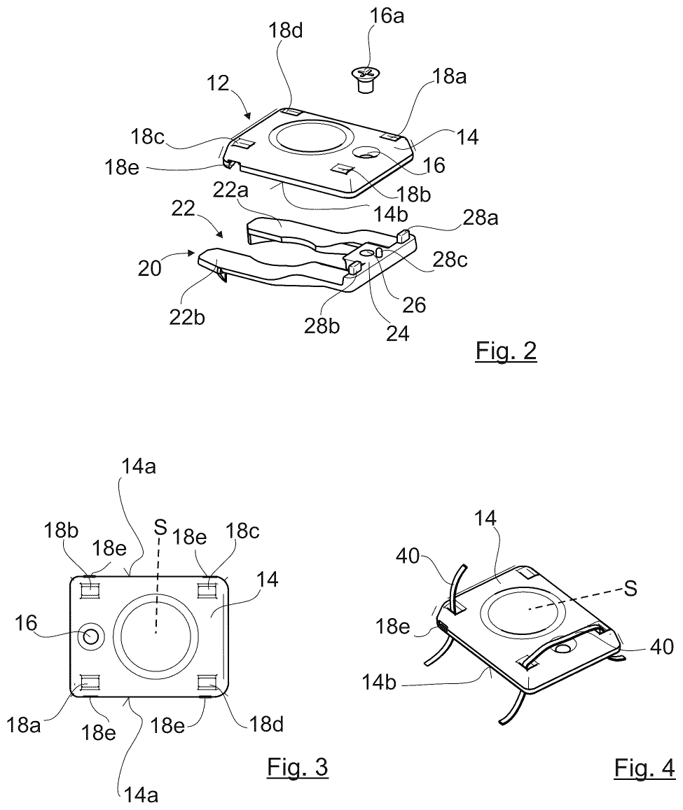

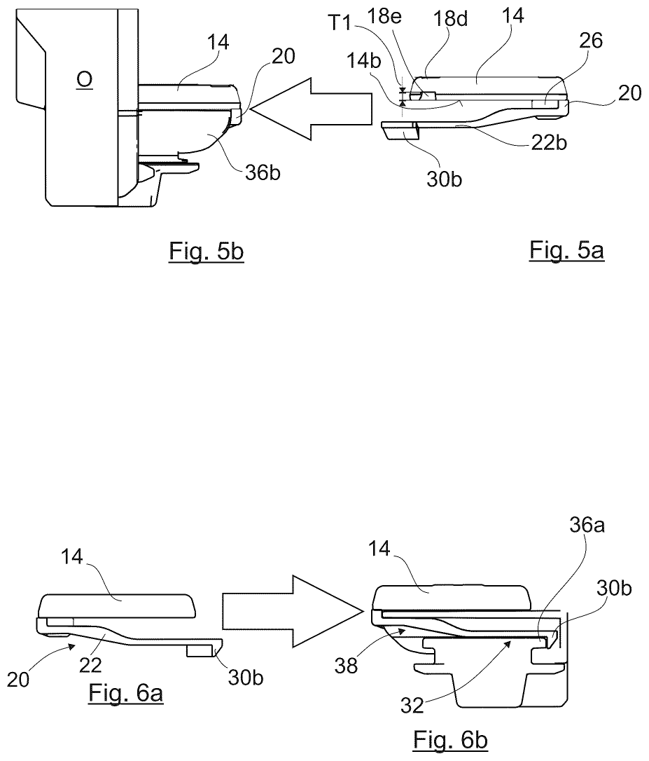

As indicated in FIGS. 2, 3 and 4 and 5a, the housing 14 of the tracking device can have at least one third fastening clearance 18e. This can be designed as shown, in the manner of a groove extending from a lateral face 14a of the housing 14 in a longitudinal direction, and opening into the first and/or the second fastening clearance 18a-d. At least one third fastening clearance 18e can be provided here. However, it is particularly favourable when each of the second fastening clearances is assigned a third fastening clearance, as indicated in FIG. 3.

The housing 14 has a contact face 14b which can be brought to rest on an object to fasten the latter. The groove, or third fastening clearance 18e, is attached to the contact face 14b and extends from a lateral face 14a of the housing 14 adjacent to the contact face 14b (towards which it is open) in the manner of a channel up to the associated second fastening clearance 18a-d into which it opens.

This design embodiment enables a cable tie 40 to be able to be guided in the groove on the contact face 14b up to the assigned second fastening clearance 18a-d. As a result, this allows the contact face 14b of the housing 14 to rest without play, or almost without play, on the object to be located, even when using strap-type fastening elements 40 such as a cable tie, a string or a strap.

The third fastening clearance 18e can be shaped in particular in such a way that it has its smallest depth Tl in the region of the lateral face of the housing and its greatest depth in the transition region to the first and/or second fastening clearance. The depth of the groove thus denotes its extent from the contact face of the housing to the groove base. Furthermore, the depth of the groove can be designed to increase linearly, progressively or regressively. Mixed forms are also conceivable. The groove-shaped third fastening clearance enables that even less flexible fastening elements, which when deflected from the first or the second fastening clearance do not have a kink but a curvature radius, can be guided within the third fastening clearance in order to enable resting of the contact face of the housing on the object to be located without play, or almost without play.

Furthermore, the holding bracket 20 has a contact portion 24 on which the housing 14 can come to rest in a defined manner by way of one side, for example by way of the contact face 14b.

As can be furthermore seen in the figures, the holding bracket 20 is releasably connectable to the housing 14 by means of a fastening element received in the fastening clearance 16 of the housing 14 of the tracking device 12, in particular a screw 16a. For this purpose, for example, as can be seen in FIG. 2, a receptacle opening 26 into which the screw 16a can be screwed when the housing 14 of the tracking device 12 is placed on the holding bracket 20, in particular on the contact portion 24, is provided on the holding bracket 20, in particular in the region of the contact portion 24. In this state, the housing 14 is aligned, for example, via additional centring structures in the form of protrusions 28a, 28b on the holding bracket 20, in particular on the contact portion 24, in such a way that the receptacle opening 26 is co-aligned with the fastening clearance 16. A screw S received from the opposite side of the housing 14 in the fastening clearance 16 extends through this into the receptacle opening 26 and can be screwed into an internal thread provided therein. Alternatively, a self-tapping screw S can also be used, which is screwed into the material of the holding bracket 20 in the region of the receptacle opening 26 and cuts in a thread in the process.

The holding bracket 20 can be made completely or in portions, for example in the region of the contact portion 24, of plastics material or the like.

The centring structures on the holding bracket 20, in particular the protrusions 28a, 28b shown by way of example in the region of the contact portion 24 on the holding bracket 20, are designed and aligned in such a manner, for example, that they engage in likewise existing mating structures on the housing 14 or can be placed laterally on the latter in order to align the housing 14 to the holding bracket 20. Thus, the protrusions 28a, 28b shown project in the region of the contact portion 24 in the direction of a housing 14 which can be attached thereto in such a way that they are capable of engaging in the fastening clearances 18a, 18b in a centring manner in a desired alignment of the housing 14 relative to the contact portion 24.

Thus, the housing 14 of the tracking device 12 shown in the figures has at least one first fastening clearance 16a for receiving a fastening element of a first type, in particular a screw S, and at least one second (in the embodiment shown four) fastening clearance(s) 18a to d for receiving one or more fastening elements (in the embodiment shown two) 40 of a second type, for example cable ties or the like, wherein the fastening element of the first type, in particular the screw S, and the fastening element of the second type, in particular the cable ties, differ in terms of their dimensions, their type of material and/or the type of fastening effected.

It is not shown that the tracking system has at least one first holding bracket 20 having a first connection contour, and at least one further holding bracket having an alternative connection contour, wherein the first connection contour and the alternative connection contour differ in terms of their contour shape in such a way that the first connection contour is connectable in a form-fitting manner to a first mating contour on the object to be located, and the alternative connection contour is connectable in a form-fitting manner to a second mating contour, deviating from the first mating contour, on the object to be located.

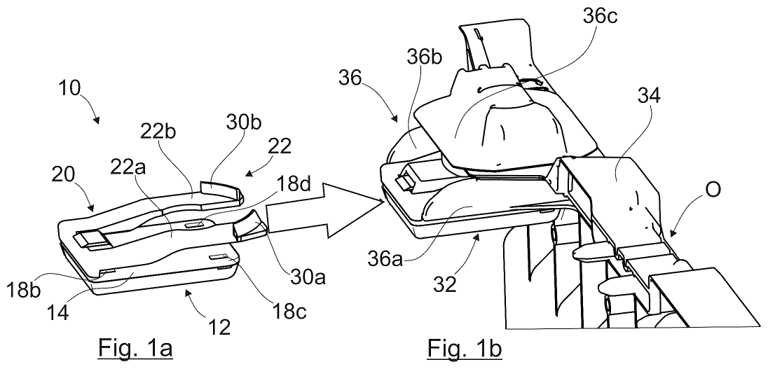

It can furthermore be seen in FIGS. 1 and 2 that the at least one holding bracket 20 furthermore comprises in the region of their connection contour 22 two holding webs 22a, 22b, wherein at least one of the holding webs 22a, 22b is elastically deflectable relative to the other holding web and/or relative to the receptacle portion 24 of the holding bracket 20, and wherein optionally at least one holding web 22a, 22b has a protrusion 30a, 30b, which can in the manner of a latching pawl be brought to engage in a form-fitting manner with the mating contour 32 of the object O to be located.

In FIGS. 1a and 1b, in particular in sub-figure FIG. 1b, it can be seen that the object O to be located can comprise a container of a container system (comprising at least one container) having at least one mating contour 32 on a container wall 34. The tracking system 10 shown by way of example can be attached to this corresponding mating contour 32 as shown. In the example shown, the mating contour 32 is formed integrally to the container wall 34.

Thus, in the example of FIGS. 1a and 1b shown, the at least one mating contour comprises a receptacle 36 in which, in a state of the tracking system 10 attached to the container, the at least one holding bracket 20 can be received at least in portions.

In the embodiment shown, the receptacle 36 is laterally delimited by wall elements 36a, 36b. In addition, at least one protrusion 36a is provided, in particular on an upper or lower face 36c of the receptacle 36.

The holding bracket 20 engages by way of the holding webs 22a, 22b in a narrow clearance 38 and in its end position relative to the receptacle 36 engages behind a protrusion 36a. The respective protrusion 30a, 30b of the holding webs 22a, 22b is guided in the clearance 38 and slightly (in the design embodiment and orientation shown) deflected upwards, i.e. in the direction of the housing 14, and latches backwards in the end position relative to the receptacle 36, in order to engage in a form-fitting manner with the protrusion 36a.

The at least one mating contour 32 comprises a housing-shaped receptacle 36, in which the tracking system 10 can be completely or almost completely received in such a way that a face which in the received state of the tracking system 10 is an outer face (for example the lateral housing faces) of the tracking system 10 can terminate so as to be almost flush with an adjacent face (for example the wall elements 36a, 36b) of a container wall 34.

1-10. (canceled)

11. A tracking system for wirelessly locating a connected object, the tracking system comprising:
a tracking device comprising a housing for receiving a transmission installation for wireless transmission of location data to an external apparatus, wherein the housing of the tracking device has at least one fastening clearance for releasably receiving a fastening element; and
at least one holding bracket, wherein the holding bracket is releasably connectable to the housing of the tracking device and has a connection contour which is configured to establish a form-fitting connection to a mating contour of an object to be connected to the tracking system in such a manner that the tracking device of the tracking system for wirelessly locating the connected object is configured to be releasably fastened to the object to be located by means of the holding bracket or by means of a fastening element.

12. The tracking system of claim 11, wherein the holding bracket is releasably connectable to the housing by means of a fastening element which is received in the fastening clearance of the housing of the tracking device.

13. The tracking system of claim 11, wherein the housing of the tracking device has at least one first fastening clearance for receiving a fastening element of a first type and at least one second fastening clearance for receiving a fastening element of a second type, wherein the fastening element of the first type and the fastening element of the second type differ in terms of their dimensions, their type of material and/or the type of fastening effected.

14. The tracking system of claim 13, wherein the housing of the tracking device has at least one third fastening clearance which is formed in the manner of a groove extending from a lateral face of the housing and opening into the first and/or the second fastening clearance.

15. Tracking system of claim 14, wherein the at least one third fastening clearance has a smallest depth in the region of the lateral face of the housing and a greatest depth in a transition region to the first and/or the second fastening clearance.

16. The tracking system of claim 11, wherein the tracking system has at least one first holding bracket having a first connection contour and at least one second holding bracket having a second connection contour, wherein the first connection contour and the second connection contour differ in terms of the contour shape in such a manner that the first connection contour is connectable in a form-fitting manner to a first mating contour on the object to be located, and the second connection contour is connectable in a form-fitting manner to a second mating contour on the object to be located.

17. The tracking system of claim 11, wherein the at least one holding bracket comprises two holding webs, wherein at least one of the holding webs is elastically deflectable relative to the other holding web and/or relative to a further portion of the holding bracket, and wherein at least one holding web has a protrusion which can in the manner of a latching pawl be brought to engage in a form-fitting manner with the mating contour of the object to be located.

18. A container system comprising a container having at least one mating contour on a container wall, and at least one tracking system according to claim 11.

19. The container system of claim 18, wherein the at least one mating contour comprises a receptacle, in which the at least one holding bracket, in a state of the tracking system attached to the container, can be received at least in sections.

20. The container system of claim 18, wherein the at least one mating contour comprises a housing-shaped receptacle in which the tracking system can be received almost completely in such a manner that an outer face of the tracking system in the received state of the tracking system is able to close almost flush with an adjacent face of a container wall.
